(19) United States
(12) Patent Application Publication
(10) Pub. No.: US 2008/0225216 A1
(43) Pub. Date: Sep. 18, 2008

(54) ACTIVE MATRIX CIRCUIT SUBSTRATE AND DISPLAY DEVICE

(75) Inventor: Yasuhiro SHIMODAIRA, Fujimi (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/048,554

(22) Filed: Mar. 14, 2008

(30) Foreign Application Priority Data
Mar. 15, 2007 (JP) 2007-066839
Jan. 18, 2008 (JP) 2008-009270

(51) Int. Cl. G02F 1/1343

(52) U.S. Cl. 349/143

(57) ABSTRACT

An active matrix circuit substrate includes: a substrate having an avoidance portion provided in a predetermined region; a plurality of pixel electrodes provided on the substrate; a driving circuit that is provided on the substrate and drives the a plurality of pixel electrodes; a plurality of wiring lines which are provided on the substrate and include a plurality of power lines electrically connected to the driving circuit and a part of which has a detour portion that makes a detour to avoid the avoidance portion; and a connecting portion which is provided in the periphery of the avoidance portion on the substrate and which is connected to the power lines such that the plurality of power lines are packed.

### BACKGROUND

1. Technical Field

The present invention relates to an active matrix circuit substrate including a driving electrode and a wiring line pattern and a display device having the active matrix circuit substrate.

2. Related Art

In recent years, as various kinds of display devices (displays), such as electro-optical devices, are widespread, it is considered to use such display devices even for display units of watches or various kinds of instruments. In some display devices that are thus used as display units of watches or various kinds of instruments, it is necessary to form a through hole in order to attach an indicator used to indicate a time in a watch or a scale mark (numerical value) in an instrument, for example. As a display device in which a through hole is formed, a liquid crystal display device that uses STN liquid crystal, which is driven in a passive matrix driving method, has been proposed (for example, refer to JP-A-2001-75112).

However, even for a display device used in a watch or the like, there is a demand to perform display on the basis of an active matrix driving method rather than a passive matrix driving method in order to not only display numbers simply indicating a time but also perform display related to calendar information, such as ‘date’ or ‘day of the week’, and display related to various kinds of functions (for example, a timer function, a stopwatch function, and an electric wave receiving function) additionally provided in an instrument, such as a watch.

However, in order to perform active matrix driving, it is necessary to dispose wiring lines, such as data lines and scanning lines, in vertical and horizontal directions. If a through hole is formed in an active matrix circuit substrate used as a constituent component of a display device as described above, a data line or a scanning line located at the through hole is damaged. For example, in the case when a display device that uses the active matrix circuit substrate is a rectangular screen, display is not realized in a cross-shaped portion including a through hole, that is, a display portion using a pixel electrode connected to a wiring line passing through the through hole in terms of design. Accordingly, for wiring lines passing through a through hole in terms of design, it is necessary to cause a wiring line portion passing through the through hole to make a detour to avoid the through hole in a matrix display having the through hole.

In addition, JP-A-2001-75112 discloses a liquid crystal display device having a through hole within a display unit so as to be also used in an analog indicating instrument, in which highly dense wiring is possible by effectively using a peripheral space of the through hole and special display can be performed in the periphery of the through hole by forming an electrode portion having a shape of a circular arc, which has a predetermined curvature having an axis line of the through hole as a center, in each of X and Y electrodes wired around the through hole. However, active matrix driving based on a TFT panel is not considered at all in JP-A-2001-75112. Accordingly, the liquid crystal display device disclosed in JP-A-2001-75112 cannot meet the demand to perform display on the basis of the active matrix driving method.

As described above, in an active-matrix-type high definition display device, it is necessary to cause wiring lines, such as data lines (signal lines) or scanning lines, to make a detour to avoid a through hole. However, in order to array the wiring lines in a condition where the wiring lines make a detour to avoid the through hole, a pixel driving circuit for driving a pixel electrode cannot be provided at the position where the corresponding wiring line is formed. Particularly in the case of a high-resolution display device, the number of wiring lines that make a detour is noticeably increased. Accordingly, a region where the pixel driving circuit is formed is also restricted as much as the increased number of wiring lines. As a result, since display cannot be realized in the periphery of the through hole, the entire display area is decreased.

### SUMMARY

An advantage of some aspects of the invention is that it provides an active-matrix-driving-type display device capable of securing a large display area without lowering the display quality and causing a significant increase in manufacturing cost and an active matrix circuit substrate used as a constituent component of the display device.

According to an aspect of the invention, an active matrix circuit substrate includes: a substrate having an avoidance portion provided in a predetermined region; a plurality of pixel electrodes provided on the substrate; a driving circuit that is provided on the substrate and drives the a plurality of pixel electrodes; a plurality of wiring lines which are provided on the substrate and include a plurality of power lines electrically connected to the driving circuit and a part of which has a detour portion that makes a detour to avoid the avoidance portion; and a connecting portion which is provided in the periphery of the avoidance portion on the substrate and which is connected to the power lines such that the plurality of power lines are packed.

According to the aspect of the invention, the connecting portion connected to the power lines is provided in the periphery of the avoidance portion on the substrate such that a predetermined number of power lines of the plurality of power lines connected to the driving circuit for driving the pixel electrodes are packed. Accordingly, a space where power lines are provided can be saved as much as the packed amount. Since it is possible to make a detour to avoid the avoidance portion while saving the space for power lines, it is possible to secure a large display area increased as much as the saved amount. The ‘avoidance portion’ refers to, for example, a region where wiring lines cannot be physically disposed, such as a through hole provided in a substrate, or a region where wiring lines cannot be disposed due to a short circuit, such as a region where other wiring lines are provided.

In the active matrix circuit substrate described above, it is preferable that the connecting portion be provided in the outermost periphery of the detour portions of the plurality of wiring lines as viewed from the avoidance portion.

In the invention, since the connecting portion is provided in the outermost periphery of the detour portions of the plurality of wiring lines as viewed from the avoidance portion, the power lines can be easily packed. As a result, a space used to avoid the avoidance portion can be largely saved.

Furthermore, in the active matrix circuit substrate described above, it is preferable that the connecting portion be connected to all of the plurality of power lines.

In the invention, since the connecting portion is connected to all of the plurality of power lines, a space where power lines are disposed can be significantly saved.

Furthermore, in the active matrix circuit substrate described above, it is preferable that the connecting portion be provided in an annular shape so as to surround the avoidance portion.

In the invention, since the connecting portion is provided in an annular shape so as to surround the avoidance portion, not only power lines can be packed but also the power lines can be connected to the connecting portion from any direction around the avoidance portion. Thus, the avoidance portion can be easily avoided.

According to another aspect of the invention, a display device includes: first and second substrates which are disposed opposite to each other with an electro-optical material layer interposed therebetween; a pixel electrode provided on a surface of the first substrate facing the second substrate; and a counter electrode provided on a surface of the second substrate facing the first substrate. The first substrate is the active matrix circuit substrate described above.

In the invention, since the active matrix circuit substrate capable of securing a large display area by making a detour to avoid the avoidance portion while saving the space of wiring lines is mounted, it is possible to obtain an active-matrix-driving-type display device capable of securing a large display area without lowering the display quality and causing a significant increase in manufacturing cost.

In the display device described above, it is preferable that the electro-optical material layer include electrophoretic particles and electrophoretic dispersion liquid formed of a liquid phase dispersion medium for dispersing the electrophoretic particles.

In the invention, an electrophoretic element that forms the display device has a display holding property (memory property). Accordingly, for example, even if an electric field is not applied to electrophoretic particles when display is fixed, the display is held in a state based on a previously applied potential. Accordingly, it becomes possible to reduce power consumption.

### BRIEF DESCRIPTION OF THE DRAWINGS

The invention will be described with reference to the accompanying drawings, wherein like numbers reference like elements.

FIG. 1 is a front view illustrating a wristwatch related to a display device according to an embodiment of the invention.

FIG. 2 is a side sectional view illustrating a wristwatch.

FIG. 3 is a side sectional view illustrating a display device.

FIG. 4A is a view explaining an operation of an electrophoretic element.

FIG. 4B is a view explaining an operation of an electrophoretic element.

FIG. 5 is a view illustrating a display region excluding the periphery of a through hole of a display device.

FIG. 6 is an equivalent circuit diagram illustrating a pixel portion of a display device.

FIG. 7 is a plan view illustrating the configuration of a display device.

FIG. 8 is a plan view illustrating the configuration of a part of a display device.

FIG. 9 is a view illustrating the cross-sectional configuration of a first substrate of a display device.

FIG. 10 is a view illustrating the cross-sectional configuration of a first substrate of a display device.

FIG. 11A is a view illustrating an effect obtained by packing wiring lines for power lines.

FIG. 11B is a view illustrating an effect obtained by packing wiring lines for power lines.

FIG. 12 is a plan view illustrating the configuration of a display device according to a second embodiment of the invention.

FIG. 13 is a plan view illustrating the configuration of a display device according to a third embodiment of the invention.

FIG. 14 is a plan view illustrating the configuration of a display device according to a fourth embodiment of the invention.

FIG. 15 is a plan view illustrating the configuration of a display device according to a fifth embodiment of the invention.

FIG. 16 is a plan view illustrating another configuration of a display device according to the fifth embodiment of the invention.

FIG. 17 is a plan view illustrating another configuration of the display device of the invention.

FIG. 18 is a plan view illustrating still another configuration of the display device of the invention.

FIG. 19 is a plan view illustrating still another configuration of the display device of the invention.

FIG. 20 is a plan view illustrating various kinds of instruments of an automobile having the display device of the invention.

### DESCRIPTION OF EXEMPLARY EMBODIMENTS

### First Embodiment

Hereinafter, a first embodiment of the invention will be described with reference to the accompanying drawings.

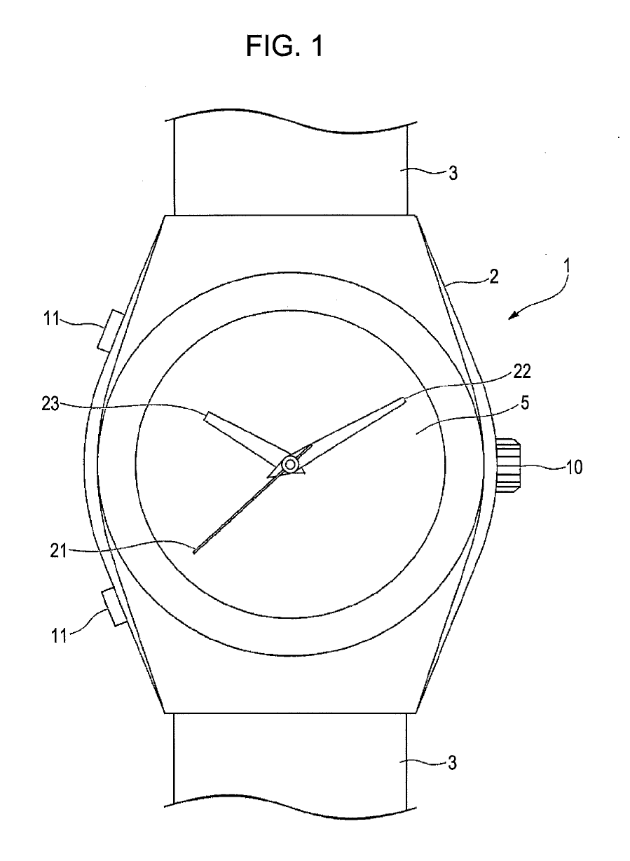

FIG. 1 is a front view illustrating a wristwatch 1 having a display device according to the present embodiment.

As shown in the drawing, the wristwatch 1 is configured to include a watch case 2 and a pair of bands 3 connected to the watch case 2 as main components.

The watch case 2 is formed of metal, such as a stainless steel, or a resin, such as a plastic resin. A display device 5, a second hand 21, a minute hand 22, and an hour hand 23 are provided on a front surface of the watch case 2. A winder 10 and an operation button 11 serving as handlers are provided on a side surface of the watch case 2. The winder 10 is connected to a spring (not shown) provided inside the case and is provided so as to freely rotate and be freely pushed or pulled in multiple steps (for example, two steps) in a state where the winder 10 is formed integrally with the spring.

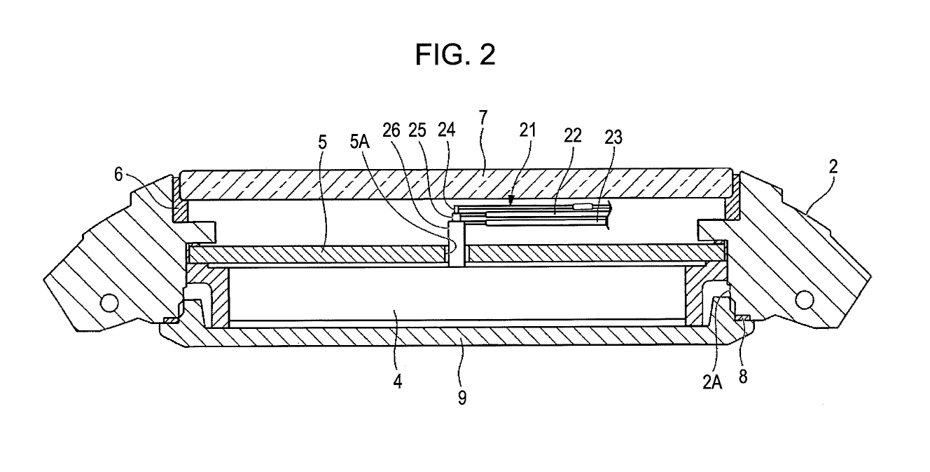

FIG. 2 is a side sectional side illustrating the wristwatch 1.

As shown in the drawing, a housing unit 2A is provided inside the watch case 2. A movement 4 and the display device 5 are provided in the housing unit 2A.

The movement 4 has a hand driving mechanism (not shown) to which analog indicators including the second hand 21, the minute hand 22, and the hour hand 23 are connected. The movement 4 serves as a time display unit displaying a set time since the hand driving mechanism performs rotational driving for the analog indicators 21 to 23.

The display device 5 is formed by using an active matrix driving electrophoretic display device, for example, and is disposed at a side of the movement 4 toward a front surface of the watch. This display device 5 forms a display unit of the wristwatch 1. Here, a display surface of the display device 5 has a circular shape. The display surface may also have other shapes, such as a regular octagonal shape or a hexadecagonal shape, as well as the circular shape.

A through hole 5A passing through front and back surfaces of the display device 5 is formed in a middle portion of the display device 5. Shafts including a second wheel 24, a second wheel 25, and a tubular wheel 26 of the hand driving mechanism (not shown) of the movement 4 are inserted in the through hole 5A. The second hand 21, the minute hand 22, and the hour hand 23 described above are attached to front ends of the shafts, respectively.

A transparent cover 7 formed of glass or resin is provided at an end side (front side of the watch) of the housing unit 2A. The transparent cover 7 is pressed and fixed to the housing unit 2A through a press ring 6 formed of resin or metal. A bottom lid 9 is screwed to the other end side (bottom side of the watch) of the housing unit 2A through packing 8. The watch case 2 is reliably sealed by the bottom lid 9 and the transparent cover 7.

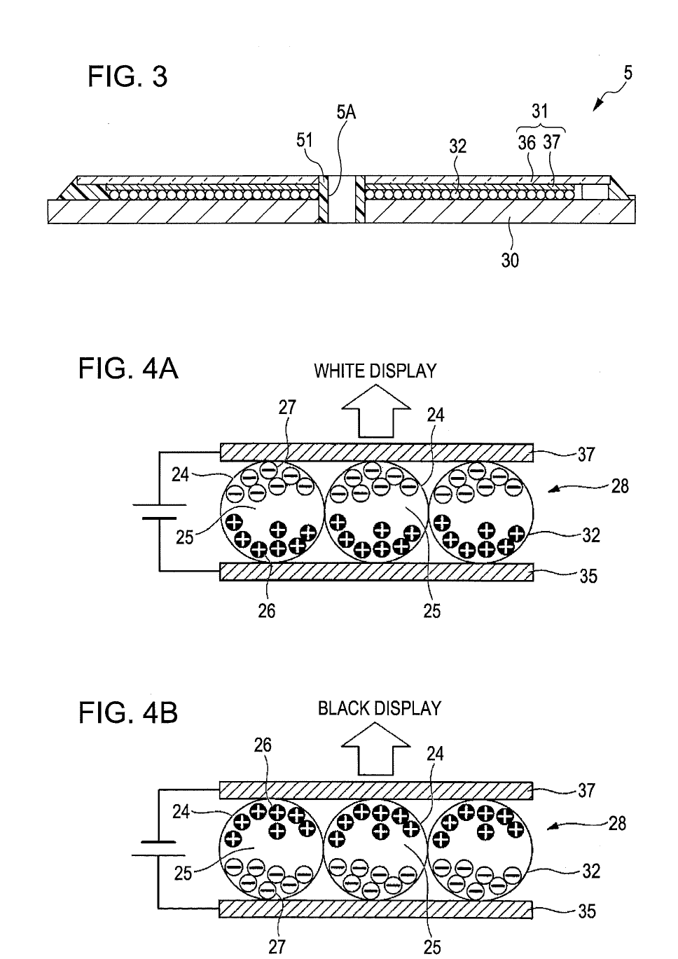

FIG. 3 is a cross-sectional view schematically illustrating the configuration of the display device 5.

As shown in the drawing, the display device 5 is configured to include a first substrate (active matrix circuit substrate) 30, a second substrate 31, and an electrophoretic layer 32 as main components.

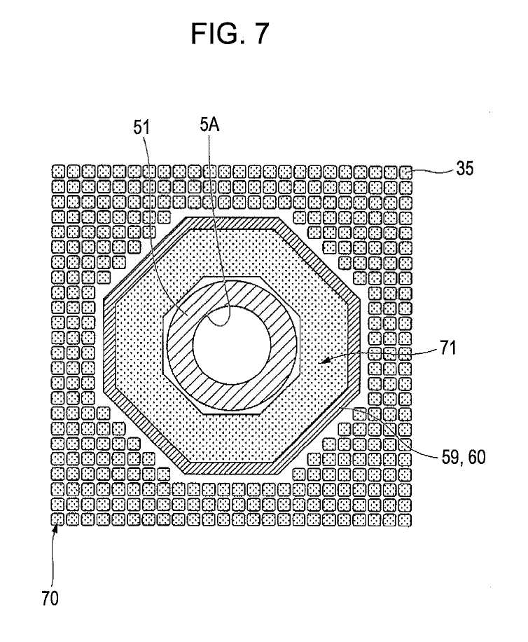

The first substrate 30 and the second substrate 31 are disposed opposite to each other with the electrophoretic layer 32 interposed therebetween. Pixel electrodes 35 (refer to FIG. 7) are formed on an inner surface (surface opposite the second substrate) of the first substrate 30. A common electrode (counter electrode) 37 formed of a transparent conductive material, such as an ITO, is formed on an inner surface (surface opposite the first substrate 30) of the second substrate 31. An outer surface of the second substrate 31 is a display surface on which an image, such as a still image or a moving image, is displayed. The above-described through hole 5A is formed in the middle of the first and second substrates 30 and 31. The through hole 5A is formed to pass through regions of the first and second substrates 30 and 31 overlapping each other in plan view.

A sealed portion 51 is provided on an inner side surface of the through hole 5A. The sealed portion 51 is provided such that a region (region where the electrophoretic layer 32 is provided) between the first substrate 30 and the second substrate 31 is sealed.

The electrophoretic layer 32 is configured to include a plurality of microcapsules 24 as main components as shown in FIGS. 4A and 4B. Electrophoretic dispersion liquid (electro-optical material) 25 is included in each microcapsule 24. The electrophoretic dispersion liquid 25 has a configuration in which a plurality of positively charged black electrophoretic particles (hereinafter, referred to as black particles) 26 and a plurality of negatively charged white electrophoretic particles (hereinafter, referred to as white particles) 27 are dispersed in a liquid phase dispersion medium (not shown). The electrophoretic dispersion liquid 25 is not limited to using two kinds of particles as described above but may use one kind of particle. In this case, a colored liquid phase dispersion medium may also be used. In both a case of using two kinds of particles and a case of using a kind of particle, various colors other than white and black may be used as colors of particles.

An operation of an electrophoretic element 28 will now be described. As shown in FIG. 4A, in the case when the electric potential of the common electrode 37 is relatively higher than the electric potential of the pixel electrode 35, the negatively charged white particles 27 move (are electrophoresed) to a side of the common electrode 37 and the positively charged black particles 26 move (are electrophoresed) to a side of the pixel electrode 35. As a result, a white color is recognized in a pixel portion corresponding to the electrophoretic element 28 when a side of the common electrode 37 that is a display surface side is viewed.

On the other hand, as shown in FIG. 4B, in the case when the electric potential of the pixel electrode 35 is relatively higher than the electric potential of the common electrode 37, the positively charged black particles 26 move (are electrophoresed) to the side of the common electrode 37 and the negatively charged white particles 27 move (are electrophoresed) to the side of the pixel electrode 35. As a result, a black color is recognized in a pixel portion corresponding to the electrophoretic element 28 when a side of the common electrode 37 is viewed. Thus, since each pixel portion is displayed in a white color or a black color, white or black pattern display becomes possible in the display device 5 in which the pixel portions are arrayed basically in a matrix.

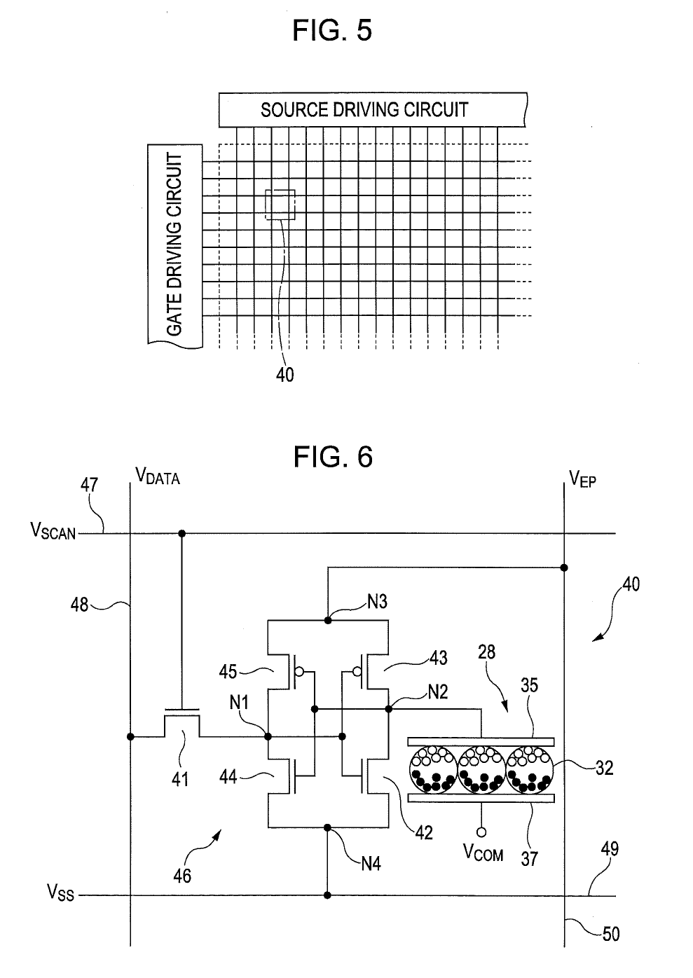

FIG. 5 is a plan view schematically illustrating the configuration of pixels of the display device 5.

In a display region 70 (refer to FIG. 7) of the display device 5 excluding the periphery 71 (refer to FIG. 7) of the through hole 5A in plan view, the pixel portions 40 are arrayed in a matrix in plan view as shown in FIG. 5. Each pixel portion 40 includes a transistor 41 serving as a switching element, a latch circuit 46 formed by combination of four transistors 42, 43, 44, and 45, and the electrophoretic element 28 as shown in a circuit diagram of FIG. 6. The transistor 41 and the latch circuit 46 form a pixel driving circuit 34.

The transistor 41 is a field effect n-channel transistor, for example. A gate of the transistor 41 is connected to a scanning line 47, one (input end) of source and drain of the transistor 41 is connected to a data line (signal line) 48, and the other one (output end) of source and drain of the transistor 41 is connected to an input end of the latch circuit 46.

The latch circuit (flip-flop circuit) 46 is formed by combination of the two field effect n-channel transistors 42 and 44 and the two field effect p-channel transistors 43 and 45, for example. Ones of sources and drains of the transistors 42 and 43 are connected to each other, the other one of source and drain of the transistor 42 is connected to a low-voltage power line 49, and the other one of source and drain of the transistor 43 is connected to a high-voltage power line 50. Similarly, ones of sources and drains of the transistors 44 and 45 are connected to each other, the other one of source and drain of the transistor 44 is connected to the low-voltage power line 49, and the other one of source and drain of the transistor 45 is connected to the high-voltage power line 50.

The gates of the transistors 42 and 43 are connected to a connection point N1 between the ones of sources and drains of the transistors 44 and 45. The connection point N1 functions as an input end of the latch circuit 46. The input end N1 is connected to the other one (output end) of source and drain of the transistor 41. The gates of the transistors 44 and 45 are connected to a connection point N2 between the ones of sources and drains of the transistors 42 and 43. The connection point N2 functions as an output end of the latch circuit 46. The output end N2 of the latch circuit 46 is connected to the pixel electrode 35, that is, an electrode at one side of the electrophoretic element 28. In the latch circuit 46 having the above-described configuration, a low potential VSS appears at the output end N2 when an electric potential applied to the input end N1 is a high potential and a high potential VEP appears at the output end N2 when an electric potential applied to the input end N1 is a low potential.

FIG. 7 is a plan view illustrating the schematic configuration of the display device 5. As shown in FIG. 7, the pixel electrodes 35 are arrayed in a matrix in the display region 70, and the pixel electrode 35 is not provided in the periphery 71 of the through hole 5A. Wiring lines used to transmit various kinds of signals are provided in the periphery 71 of the through hole 5A.

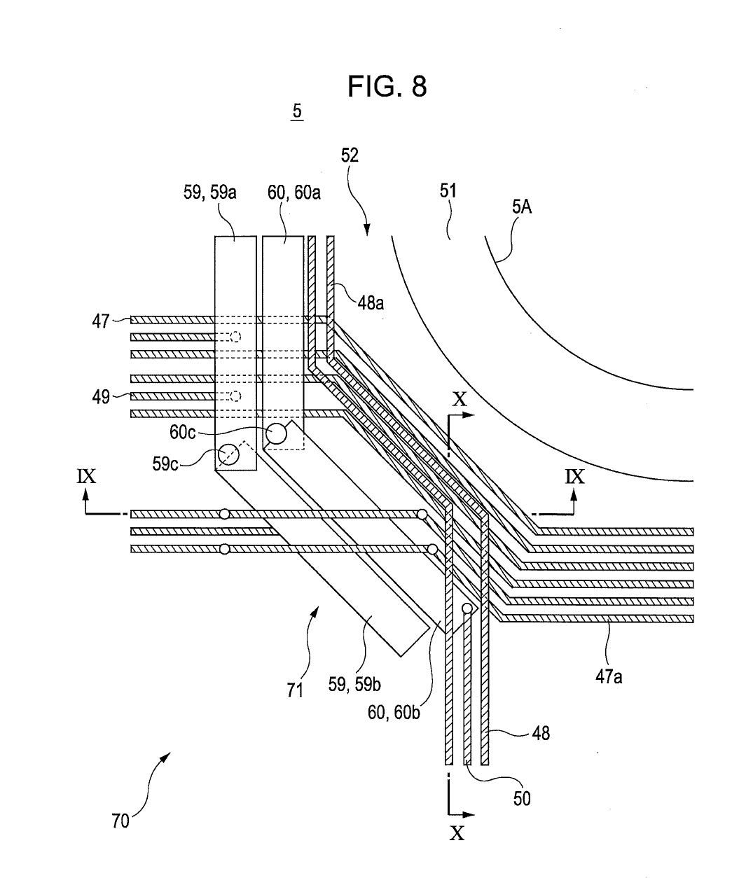

FIG. 8 is a plan view illustrating the configuration of the periphery 71 of the through hole 5A of the display device 5.

As shown in the drawing, in the display region 70, the scanning lines 47 are arrayed along the column direction of a matrix while extending in the row direction of the matrix, and the low-voltage power lines 49 are arrayed along the column direction of the matrix while extending in the row direction of the matrix in the same manner as the scanning lines 47. In the display region 70, the low-voltage power lines 49 and the scanning lines 47 are alternately provided in the column direction (arrangement direction of the low-voltage power lines 49 and the scanning lines 47) of the matrix.

Furthermore, in the display region 70, the data lines 48 are arrayed along the row direction of the matrix while extending in the column direction of the matrix, and the high-voltage power lines 50 are arrayed along the row direction of the matrix while extending in the column direction of the matrix in the same manner as the data lines 48. In the display region 70, the high-voltage power lines 50 and the data lines 48 are alternately provided in the row direction (arrangement direction of the high-voltage power lines 50 and the data lines 48) of the matrix.

The periphery 71 of the through hole 5A is a portion disposed at the position passing through the through hole 5A in terms of design, that is, a portion disposed to pass through a portion where the through hole 5A is formed if the through hole 5A is not present. In this portion, both the scanning lines 47 and the data lines 48 are provided with detour wiring lines 47a and 48a that make a detour to avoid the through hole 5A.

The sealed portion 51 that seals the periphery of the through hole 5A is formed in the periphery 71 of the through hole 5A. The sealed portion 51 serves as a region through which the scanning lines 47 and the data lines 48 cannot pass. Accordingly, here, the through hole 5A and the sealed portion 51 serve as an avoidance portion. The detour wiring lines 47a and 48a that make a detour to avoid the sealed portion 51 are also provided for the scanning lines 47 and the data lines 48, which are disposed at the positions passing through the sealed portion 51 in terms of design, as well as the scanning lines 47 and the data lines 48 disposed at the positions passing through the through hole 5A in terms of design.

The scanning lines 47 and the data lines 48 located near the scanning lines 47 and the data lines 48 formed with the detour wiring lines 47a and 48a also need to be formed with detour wiring lines in order to avoid the detour wiring lines 47a and 48a. In the present embodiment, the detour wiring lines 47a and 48a are also similarly formed for the scanning lines 47 and the data lines 48. In the present embodiment, not only the through hole 5A and the sealed portion 51 but also the detour wiring lines 47a and 48a located near the through hole 5A and the sealed portion 51 serve as an avoidance portion 52.

In addition, a low-voltage connecting portion 59 connected to each low-voltage power line 49 and a high-voltage connecting portion 60 connected to each high-voltage power line 50 are provided in the periphery 71 of the through hole 5A. The low-voltage connecting portion 59 and the high-voltage connecting portion 60 are formed of metal or a conductive material, such as an ITO, and are provided in an annular shape in plan view, for example, in a shape of a regular octagon so as to surround the avoidance portion 52. The low-voltage connecting portion 59 and the high-voltage connecting portion 60 are provided at the outside of the detour wiring lines 47a and 48a in the periphery 71 of the through hole 5A and are provided in the outermost periphery of the periphery 71 of the through hole 5A. In FIG. 8, the low-voltage connecting portion 59 is provided outside and the high-voltage connecting portion 60 is provided inside. The low-voltage power lines 49 are packed into one wiring line portion by the low-voltage connecting portion 59 and the high-voltage power lines 50 are packed into one wiring line portion by the high-voltage connecting portion 60, thereby avoiding the avoidance portion 52.

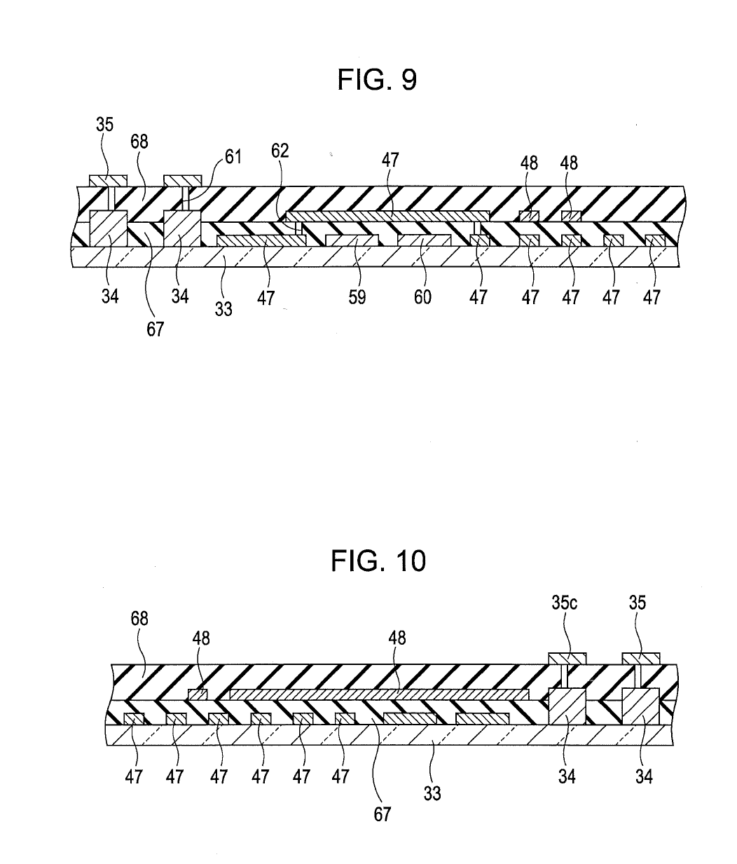

FIG. 9 is a cross-sectional view illustrating the configuration taken along the line IX-IX of FIG. 8. FIG. 10 is a cross-sectional view illustrating the configuration taken along the line X-X of FIG. 7.

As shown in FIGS. 9 and 10, the pixel driving circuit 34 is provided on a glass substrate 33. The pixel electrodes 35 are provided above the pixel driving circuits 34 and are arrayed in a matrix at the positions overlapping the corresponding pixel driving circuits 34 in plan view. The pixel electrode 35 and the pixel driving circuit 34 are electrically connected to each other through a contact hole 61.

In addition, the scanning lines 47, the low-voltage connecting portion 59, and the high-voltage connecting portion 60 are provided on the glass substrate 33. On the scanning lines 47, the low-voltage connecting portion 59, and the high-voltage connecting portion 60, an insulating layer 67 is provided so as to cover the scanning lines 47, the low-voltage connecting portion 59, and the high-voltage connecting portion 60. In a portion crossing the low-voltage connecting portion 59 and the high-voltage connecting portion 60 in plan view, the scanning line 47 is provided on the insulating layer 67 through the contact hole 62, for example. The data lines 48 are provided on the insulating layer 67. On the data lines 48, an insulating layer 68 is provided so as to cover the data lines 48. The pixel electrodes 35 are provided on the insulating layer 68.

In a region where the scanning lines 47 or the data lines 48 are provided on or above the glass substrate 33, the low-voltage connecting portion 59 and the high-voltage connecting portion 60 (for example, a low-voltage connecting portion 59a and a high-voltage connecting portion 60a extending in the column direction of FIG. 8) are provided on the insulating layer 67 so as to avoid the scanning lines 47 or the data lines 48. In a region where the scanning lines 47 or the data lines 48 are provided on the insulating layer 67, the low-voltage connecting portion 59 and the high-voltage connecting portion 60 (for example, a low-voltage connecting portion 59b and a high-voltage connecting portion 60b extending at the inclination of 45° with respect to the column direction of FIG. 8) are provided on the glass substrate 33 so as to avoid the scanning lines 47 or the data lines 48. The low-voltage connecting portion 59a on the insulating layer 67 and the low-voltage connecting portion 59b on the glass substrate 33 are electrically connected to each other through a contact plug 59c, and the high-voltage connecting portion 60a on the insulating layer 67 and the high-voltage connecting portion 60b on the glass substrate 33 are electrically connected to each other through a contact plug 60c.

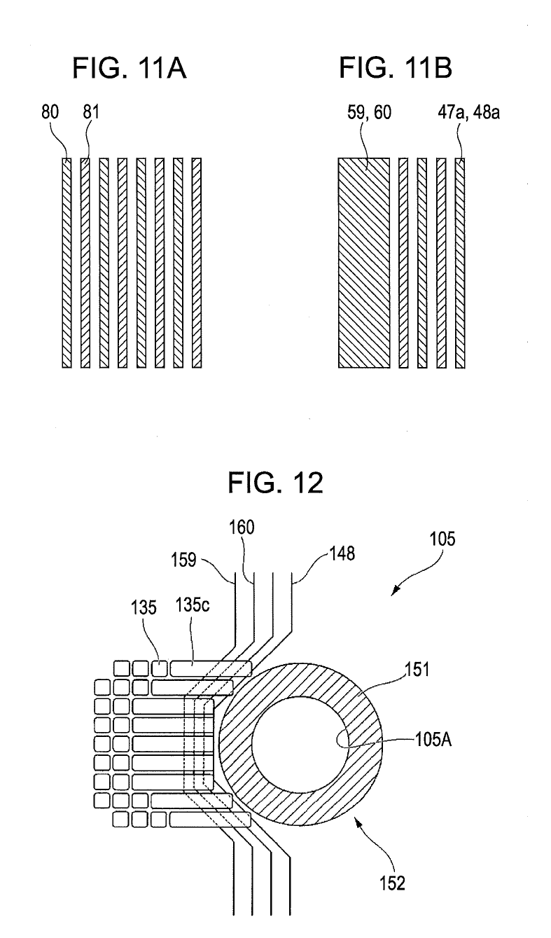

In general, in the case when pixels arrayed in a matrix are driven, power wiring lines 80 and signal wiring lines 81 (scanning lines and data lines) are alternately arrayed as shown in FIG. 11A. The power wiring lines 80 and the signal wiring lines 81 are provided for every line where pixels are arrayed. Since the power wiring lines 80 and the signal wiring lines 81 are arrayed with a gap therebetween so as not to be connected to each other, the power wiring lines 80 and the signal wiring lines 81 are disposed to spread in the line direction of pixels. For this reason, there has been a problem that a corresponding display region becomes narrow.

To the contrary, in the present embodiment, in the periphery 71 of the through hole 5A, the low-voltage connecting portion 59 and the high-voltage connecting portion 60 respectively connected to the low-voltage power lines 49 and the high-voltage power lines 50 are provided such that the low-voltage power lines 49 and the high-voltage power lines 50 connected to the pixel driving circuit 34 that drives the pixel electrodes 35 are packed, as shown in FIG. 11B. Accordingly, a space where power lines are provided can be saved as much as the packed amount. Since it is possible to make a detour to avoid the avoidance portion 52 while saving the space for the low-voltage power lines 49 and the high-voltage power lines 50, it is possible to secure a large display area increased as much as the saved amount.

### Second Embodiment

Next, a second embodiment of the invention will be described. FIG. 12 is a plan view illustrating the configuration of a display device 105 according to the present embodiment.

In the present embodiment, the display device 105 has almost the same configuration as the display device 5 according to the first embodiment but is different from the display device 5 according to the first embodiment in that pixel electrodes 135c extending from the outside of an avoidance portion 152 toward the inside of the avoidance portion 152 are provided in addition to pixel electrodes 135 arrayed in a matrix.

According to the configuration described above, the pixel electrodes 135c can also be provided in the avoidance portion 152. Accordingly, it is possible to obtain the same effects as in the first embodiment and to enlarge a display region.

### Third Embodiment

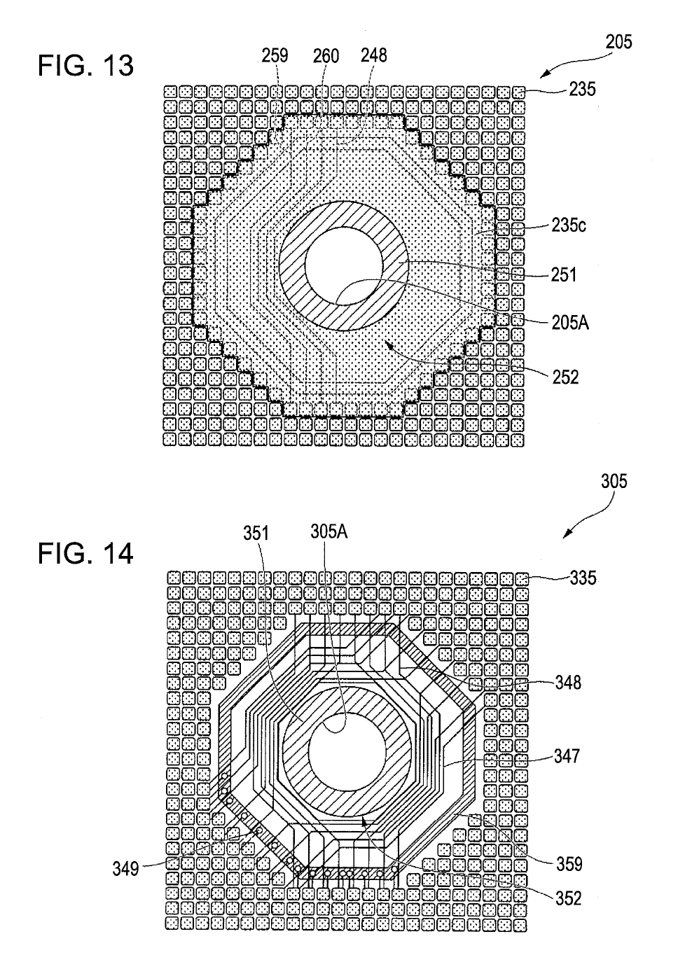

Next, a third embodiment of the invention will be described. FIG. 13 is a plan view illustrating the configuration of a display device 205 according to the present embodiment.

In the present embodiment, the display device 205 has almost the same configuration as the display device 5 according to the first embodiment but is different from the display device 5 according to the first embodiment in that pixel electrodes 235c, which have an annular shape so as to cover an avoidance portion 252, are provided in addition to pixel electrodes 235 arrayed in a matrix.

According to the configuration described above, similar to the second embodiment, the pixel electrodes 235c can also be provided in the avoidance portion 252. Accordingly, it is possible to obtain the same effects as in the first embodiment and to enlarge a display region.

### Fourth Embodiment

Next, a fourth embodiment of the invention will be described. FIG. 14 is a plan view illustrating the configuration of a display device 305 according to the present embodiment.

The display device 305 according to the present embodiment has a configuration in which scanning lines 347 are arrayed so as to be inclined (for example, by 45°) without making the scanning lines 347 and data lines 348 cross each other. In a region where pixel electrodes 335 are arrayed in a matrix, a low-voltage power line 349 is provided between the scanning lines 347 and the scanning lines 347 and the low-voltage power lines 349 are alternately arrayed. Similarly, in this region, a high-voltage power line 350 is provided between the data lines 348 and the data lines 348 and the high-voltage power lines 350 are alternately arrayed. In the periphery (avoidance portion 352) of a through hole 305A and a sealant 351, a connecting portion 359 connected to a low-voltage power line 349 and a high-voltage power line 350 is provided such that the low-voltage power lines 349 and the high-voltage power lines 350 are packed.

In addition, even though the scanning lines 347 are disposed so as to be inclined in the above configuration, the data lines 348 may be disposed so as to be inclined. In addition, even though the low-voltage power line 349 and the high-voltage power line 350 are connected to the common connecting portion 359 in the above configuration, the low-voltage power line 349 and the high-voltage power line 350 may also be connected to different connecting portions, respectively.

Thus, even in the case when the arrangement of the scanning lines 347 and the data lines 348 in the first embodiment is changed, it is possible to avoid the avoidance portion 352 while saving the space for the low-voltage power lines 349 and the high-voltage power lines 350 since the connecting portion 359, which is connected with the low-voltage power lines 349 and the high-voltage power lines 350 such that the low-voltage power lines 349 and the high-voltage power lines 350 are packed, is provided. As a result, the same effects as in the first embodiment can be obtained.

### Fifth Embodiment

Next, a fifth embodiment of the invention will be described.

In the present embodiment, only a part of an avoidance portion is formed within a display region of a display device.

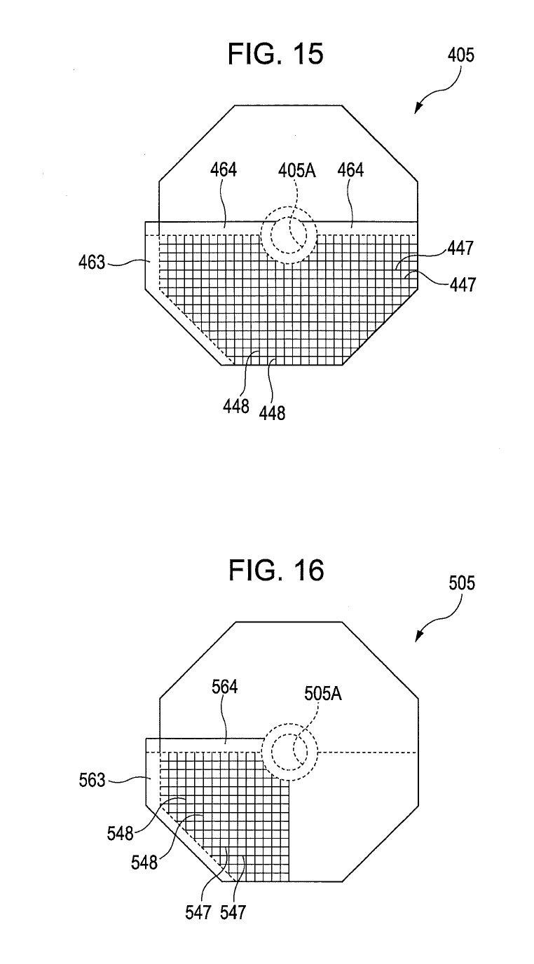

Specifically, as shown in FIG. 15, the planar shape of a display device 405 may be a regular octagon. In addition, in the case where a through hole 405A is formed in the middle of the display device 405, a display region may be formed such that a half of the through hole 405A is positioned at a side of the display region where scanning lines 447 and data lines 448 are provided and the remaining half of the through hole 405A is positioned at a non-display region side. In addition, in FIG. 15, reference numeral 463 denotes a gate driver and reference numeral 464 denotes a data driver.

As another example in which a part of an avoidance portion is formed within a display region, as shown in FIG. 16, the planar shape of a display device 505 may be a regular octagon. In addition, in the case where a through hole 505A is formed in the middle of the display device 505, a display region may be formed such that a quarter of the through hole 505A is positioned at a side of the display region where scanning lines 547 and data lines 548 are provided and the remaining portion of the through hole 505A is positioned at a non-display region side. In addition, in FIG. 16, reference numeral 563 denotes a gate driver and reference numeral 564 denotes a data driver.

Thus, by applying the invention to the configuration in which a part of an avoidance portion is formed within a display region, an active matrix circuit substrate according to the embodiment of the invention can also be applied to a display device having a relatively narrow display region. Therefore, in particular, application to a display device, which is configured to increase the life of a battery by making a display region narrow so as to suppress power consumption, becomes easy.

In addition, it should be understood that the technical scope of the invention is not limited to the above embodiments, but various modifications may be made without departing from the spirit and scope of the invention.

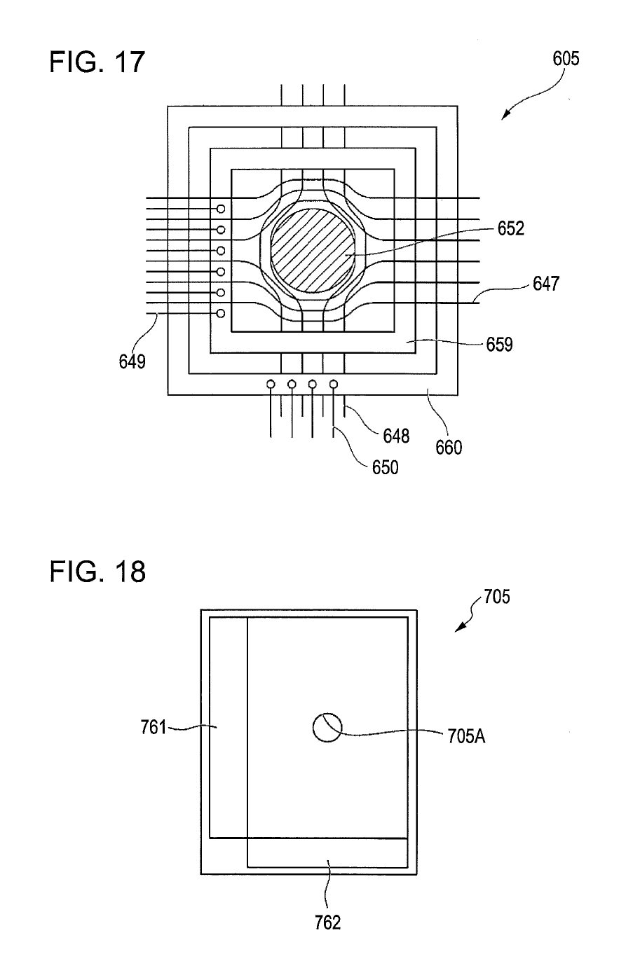

In the embodiments described above, the planar shapes of the low-voltage connecting portion and the high-voltage connecting portion are octagonal annular shapes. However, the invention is not limited thereto. For example, as shown in FIG. 17, a low-voltage connecting portion 659 and a high-voltage connecting portion 660 may also be formed to have a square annular shape.

In addition, even though the planar shapes of the low-voltage connecting portion and the high-voltage connecting portion of the display device are octagonal shapes like the embodiments described above, a low-voltage connecting portion and a high-voltage connecting portion of a display device 705 may be formed to have rectangular planar shapes and formed in different layers so as to overlap in plan view as shown in FIG. 18. Even in the case of a rectangular shape, a display region near an avoidance portion, such as a through hole 705A, can be extended. In addition, by forming the low-voltage connecting portion and the high-voltage connecting portion in rectangular shapes in different layers, it becomes not necessary to electrically connect a low potential power line with a high potential power line in different layers by using a contact plug in order to avoid scanning lines and data lines. Accordingly, it is not necessary to form a contact plug. In addition, in FIG. 18, reference numeral 761 denotes a gate driver and reference numeral 762 denotes a source driver.

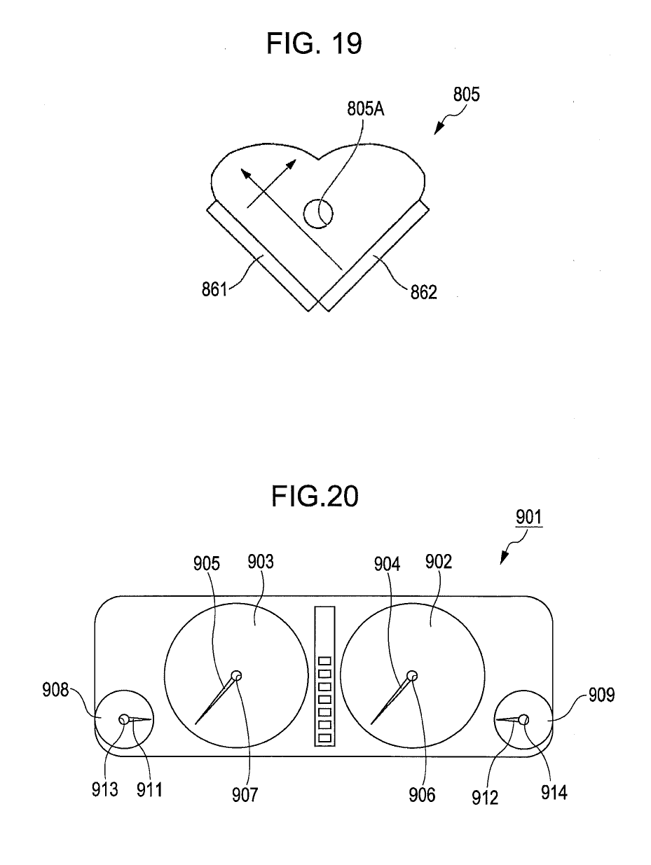

In addition, as an example of a special shape, the planar shape of a display device 805 may be a heart shape, as shown in FIG. 19. Even in this case, a display region near an avoidance portion, such as a through hole 805A, can be extended in the same manner as described above. Moreover, in FIG. 19, reference numeral 861 denotes a gate driver and reference numeral 862 denotes a source driver.

Furthermore, in the embodiments described above, an electrophoretic element is formed by using electrophoretic dispersion liquid as an electro-optical material to thereby perform display. However, for example, a liquid crystal display element may be formed by using a liquid crystal material as an electro-optical material, or an organic EL element may be formed by using an organic EL material.

Furthermore, in the above embodiments, examples in which the display device according to the embodiments of the invention is applied to a wristwatch have been described. However, it is needless to say that the display device according to the embodiments of the invention may also be applied to a stand clock, a clock, a wall clock, a pocket watch, and the like. In addition to clocks or watches, the display device according to the embodiments of the invention may also be applied to various kinds of instruments having indicators. In addition, the display device according to the embodiments of the invention may also be applied to various kinds of display devices having avoidance portions other than through holes.

Examples of a display device having an indicator provided in the middle of a display unit include various kinds of instruments, such as a speed meter 902 and a revolution meter 903 provided in an instrument panel 901 of an automobile, as shown in FIG. 20. Indicators 904 and 905 are provided in the middle of the speed meter 902 and the revolution meter 903, respectively. In addition, holes 906 and 907 into which the indicators 904 and 905 are inserted are provided in the display device. Small meters, such as a fuel gauge 908 and a coolant temperature gauge 909, are provided next to the revolution meter 903 and the speed meter 902, respectively. Indicators 911 and 912 are also provided in the small meters. In addition, holes 913 and 914 into which the indicators 911 and 912 are inserted are provided in the display device. When the display devices according to the above-described embodiments are applied to these kinds of instruments, the instruments each having a large display area can be realized. Particularly in the case when an organic EL material is used as an electro-optical material, not only a large display area can be secured but also bright display can be realized even at night due to self-luminous light.

What is claimed is:

1. An active matrix circuit substrate comprising:
a substrate having an avoidance portion provided in a predetermined region;
a plurality of pixel electrodes provided on the substrate;
a driving circuit that is provided on the substrate and drives the a plurality of pixel electrodes;
a plurality of wiring lines which are provided on the substrate and include a plurality of power lines electrically connected to the driving circuit and a part of which has a detour portion that makes a detour to avoid the avoidance portion; and
a connecting portion which is provided in the periphery of the avoidance portion on the substrate and which is connected to the power lines such that the plurality of power lines are packed.

2. The active matrix circuit substrate according to claim 1,
wherein the connecting portion is provided in the outermost periphery of the detour portions of the plurality of wiring lines as viewed from the avoidance portion.

3. The active matrix circuit substrate according to claim 1,
wherein the connecting portion is connected to all of the plurality of power lines.

4. The active matrix circuit substrate according to claim 1,
wherein the connecting portion is provided in an annular shape so as to surround the avoidance portion.

5. A display device comprising:
first and second substrates which are disposed opposite to each other with an electro-optical material layer interposed therebetween;
a pixel electrode provided on a surface of the first substrate facing the second substrate; and
a counter electrode provided on a surface of the second substrate facing the first substrate, wherein the first substrate is the active matrix circuit substrate according to claim 1.

6. The display device according to claim 5,
wherein the electro-optical material layer includes electrophoretic particles and electrophoretic dispersion liquid formed of a liquid phase dispersion medium for dispersing the electrophoretic particles.
